(19) United States
(12) Patent Application Publication
(10) Pub. No.: US 2024/0227990 A9
(43) Pub. Date: Jul. 11, 2024

(54) WAKE SHAPING DEVICE

(71) Applicant: Eric C. Ritter, Hauppauge, NY (US)

(72) Inventor: Eric C. Ritter, Hauppauge, NY (US)

(73) Assignee: Blue Sky Calm Water LLC, Hauppauge, NY (US)

(21) Appl. No.: 17/971,627

(22) Filed: Oct. 23, 2022

(51) Int. Cl. B63B 34/75; B63H 11/04

(52) U.S. Cl. CPC B63B 34/75; B63H 11/04; B63H 2011/043

(57) ABSTRACT

Shaping a wave produced by a boat traveling through the water by redirecting water from one side of the boat to the opposite side of the boat. A water inlet port and a water intake scoop on one side of the boat, a water outlet at the center or opposite side/half of the boat, a water conduit between the inlet port and the outlet, and an actuator for selectively positioning the intake scoop in one of an active position in which the intake scoop extends beyond the sides or bottom of the hull and redirects ambient water into and through the inlet port, the water conduit and the outlet, and an inactive position in which the intake scoop does not extends beyond the sides or bottom of the hull and does not redirect ambient water moving past the boat into inlet port.

### FIELD OF THE DISCLOSURE

The present disclosure relates to a wake shaping system for a boat, and more particularly, to a wake shaping system for wake surfing.

### BACKGROUND OF THE DISCLOSURE

Water skiing behind boats has been popular since the middle of the twentieth century. Throughout the late 1900's through today, inboard ski boat manufacturers continue to refine ski boat designs to produce the smallest, softest, cleanest wakes behind the boat at speeds in excess of 25 mph. The shape of the hull is optimized to create small, soft wakes for tournament waterskiing.

In the 1990s, inboard boat manufacturers began designing and manufacturing larger boats as a result of increased demand for boats that were comfortable for an entire family and that performed better on larger, public waterways. At the same time wake boarding, similar to the growth in popularity of snowboarding, emerged as a popular alternative to competition slalom style waterskiing. Unlike waterskiing, where a water skier attempts to stay low on the surface of the water in order to increase his or her speed back and forth across the wake and around buoys set in a slalom course, a wakeboarder attempts to perform tricks such as flips (“inverts”) or spins when jumping the wakes behind the boat. Therefore, a new style of inboard boat emerged that provided wakeboarders with larger, firmer wakes needed to perform wakeboard tricks.

Compared to competition waterski boats, wakeboard boats are typically larger, open bow boats with a deep-V hull, a V-drive engine mounted in the rear of the boat, and a tower to attach the tow rope at an elevated point above the boat. By placing the engine in the rear of the boat and connecting the rope to the tower above the boat, wakeboard boats allow passengers to sit in wraparound-style seating while a wakeboarder is towed behind the boat. Wakeboard boats also include ballast systems to weight the hull of the boat down and displace more water, and thereby generate larger wakes behind the boat for wake boarding. These ballast systems may be in the form of removable ballast bags, factory-installed ballast bags, internal hard plastic tanks, or lead weight positioned throughout the boat. With each ballast system, the goal is to create large, firm, and symmetrical wakes approximately 50 to 80 feet behind the boat when the boat is travelling between 18 and 25 mph.

Wake surfing has emerged as a popular counterpart to wake boarding, allowing a surfer to surf on the wake behind the same wakeboard boat. Compared to wake boarding, wake surfing is easier to learn, has a lower risk of injury, is performed closer to the boat, and has become just as popular, if not more popular, than wake boarding. Wake surfing, however, requires a different ballast configuration in boat than wake boarding. The desired wake surfing wake is located on one side (starboard, right, or driver's side; port, left, or passenger's side) of the boat, creating an asymmetrical wakesurf wake between approximately 5 and 20 feet behind the boat when the boat is travelling between 5 and 15 mph. It is desired that one side of the asymmetrical wakesurf wake be a large, curling, and asymmetrical wake for an enjoyable wake surfing experience.

Conventional wakeboard boat ballast systems place hundreds or even thousands of pounds of water ballast in bags or tanks in the bow, midship, port stern, and/or starboard stern sections of the boat. For wake boarding, all ballast is typically filled, creating a large, firm, symmetrical wake behind the boat at wake boarding speeds. For wake surfing, the ballast is only filled on one side of the boat, leaving the ballast on the opposite side empty. This configuration “sinks” or “lists” one side of the boat, tipping the boat and creating a large, unsymmetrical wake for wake surfing on the listed side of the boat at wake surfing speeds.

Conventional wake surfing ballast configurations, however, have many disadvantages. First, by weighting only one side of the boat, the boat is unbalanced and difficult to control at slower speeds. After a surfer falls, it is difficult and dangerous to return to the fallen surfer at slower speeds and with reduced visibility. Second, traditional ballast takes up a large portion of the boat's storage capacity or even the passenger space. Third, moving the ballast from one side to the other to create a surf wake on the opposite side can be difficult, time consuming, and cumbersome.

Another method that has been used to modify a boat's wake for better wake surfing is to provide the boat with one or more wake shaping water deflector plates or hydrofoils on one or both sides of the hull near the stern of the boat. As illustrated in Prior Art FIGS. 1 and 2, it is known to provide adjustable water deflector plates 128 that extend at an angle to the direction of travel for deflecting the flow of water outward away from the boat to increase the size of the cavity formed in the water behind the boat on the side of the deflector plate. The prior art deflector plate 128 in FIG. 1 is located entirely behind the transom 124 of the boat when in the inactive/retracted position, such that it does not modify the shape if the cavity formed in the water by the hull of the boat. When the deflector plate of FIG. 1 is activated by an actuator, such as a hydraulic cylinder, the deflector plate extends out from behind the transom to deflect water away from the boat (as shown in dashed lines) to deflect water away from the boat and increase the size of the cavity made in the water behind the boat on that side of the boat. The prior art deflector plate of FIG. 2 is located on the side of the hull adjacent to the stern of the boat. When the deflector plate 128 of FIG. 2 is in the inactive position the outer surface of the deflector plate is flush with the outer surface of the hull (not shown) and when activated extends outward from the hull as illustrated to deflect water away from the boat. The deflector plate 128 illustrated in FIGS. 3A and 3B is a flat plate mounted on the stern of the boat and slides along the stern of the boat from retracted inactive position entirely behind the transom as illustrated in FIG. 3A and to an extended active position in which it extends out from the side of the boat to deflect water and increase the size of the cavity created behind the boat on that side of the boat.

A drawback of prior deflector plates as illustrated in Prior Art FIGS. 1-3 is that when extended, these deflector plates create a torque on the boat that causes to boat to turn, just as a rudder causes a boat to turn. Unless the torque is counterbalanced by the driver counter steering the boat in the opposite direction the boat will undesirably turn to the side of the extended deflector plate. This makes boats with such deflector plates difficult to steer safely during wake surfing. Moreover, the constant counteracting of the torque on the boat by counter steering also produces a lot of strain on the steering mechanism of the boat and can cause the steering mechanism to rapidly wear down and fail. The extended deflector plate also creates drag that decreases fuel economy.

As a result, an improved wake shaping system that can be selectively used for cruising, water skiing, wake boarding, left-side surfing, and right-side surfing with one ballast configuration, all without requiring filling or emptying of individual ballast tanks and listing the boat dangerously to one side, is needed. It is also needed to have a wake shaping device that creates less torque on the boat when wake surfing than existing deflector plate designs, making the boat easier to drive while wake surfing.

### SUMMARY OF THE DISCLOSURE

Disclosed herein is a wake shaping system for wake boarding and wake surfing behind a boat, and preferable for wake surfing behind an inboard wakeboard boat.

One aspect of the present disclosure is a system comprising shaping a wave produced by a boat traveling through the water by redirecting water from one side of the boat to the opposite side of the boat. A water inlet port and a water intake scoop on one side of the boat, a water outlet at the center or opposite side/half of the boat, a water conduit between the inlet port and the outlet, and an actuator for selectively positioning the intake scoop in one of an active position in which the intake scoop extends beyond the sides or bottom of the hull and redirects ambient water into and through the inlet port, the water conduit and the outlet, and an inactive position in which the intake scoop does not extends beyond the sides or bottom of the hull and does not redirect ambient water moving past the boat into inlet port.

In one embodiment of the system, there is provided a wave shaping device for a boat, the boat comprising a hull, the hull having a bow, a port sidewall, a starboard sidewall, a bottom wall and a stern wall, the bottom wall and the side walls extend forwardly from the rear wall, forward portions of the side walls generally converge at the bow; a jet propulsion system having a forward facing water intake opening in the bottom wall of the hull for receiving ambient water when the boat is floating, a jet propulsion unit for receiving water from the intake opening and accelerating the water, and a jet nozzle for receiving the accelerated water from the jet propulsion unit and emitting a water jet in a rearward direction relative to the boat for propelling the boat forward, the wave shaping device comprising: a port water inlet port in the hull of the boat on the port side portion of the boat located below the water line when the boat is floating; a port water conduit inside the hull, a first end of the port water conduit in communication with the port water inlet port and a second end of the port water conduit in communication with the water intake opening of the jet propulsion system for directing ambient water from the port water inlet port to the water intake opening; a port intake scoop that is selectively movable between a) an inactive position in which the port water intake scoop does not extend beyond the side walls or bottom wall of the hull and b) an active position in which the port water intake scoop extends beyond one of a side wall and bottom wall of the hull, whereby the port intake scoop directs ambient water into the port water inlet port as the boat moves forward through the water; a port actuator for selectively moving the port intake scoop between the inactive position and the active position; a starboard water inlet port in the hull of the boat on the starboard side portion of the boat located below the water line when the boat is floating; a starboard water conduit inside the hull, a first end of the starboard water conduit in communication with the starboard water inlet port and a second end of the starboard water conduit in communication with the water intake of the jet propulsion system for directing ambient water from the starboard water inlet port to the water intake opening;

S starboard intake scoop that may be selectively movable between a) an inactive position in which the starboard water intake scoop does not extend beyond the side walls or bottom wall of the hull and b) an active position in which the starboard water intake scoop extends beyond one of a side wall and bottom wall of the hull, whereby the starboard intake scoop directs ambient water into the starboard water inlet port as the boat moves forward through the water; and a starboard actuator for selectively moving the starboard intake scoop between the inactive position and the active position.

A rearward edge of the port water intake scoop may be pivotally connected to the hull adjacent a rearward side of the port water inlet port, and the port actuator extends between the hull and a forward portion of the port water intake scoop for pivoting the port water intake scoop between the inactive position and the active position; and a rearward edge of the starboard water intake scoop may be pivotally connected to the hull adjacent a rearward side of the starboard water inlet port, and the starboard actuator extends between the hull and a forward portion of the starboard water intake scoop for pivoting the starboard water intake scoop between the inactive position and the active position.

The port intake scoop may cover the port water inlet port when in the inactive position; and the starboard intake scoop may cover the starboard water inlet port when in the inactive position.

A forward-facing surface of the port water intake scoop when in the active position may be a concave surface configured to smoothly redirect ambient water into the port water inlet port, and a forward facing surface of the starboard water intake scoop when in the active position is a concave surface configured to smoothly redirect ambient water into the starboard water inlet port.

An outer surface of the port water intake scoop when in the inactive position may be flush with an outer surface of the hull and an outer surface of the starboard water intake scoop when in the inactive position is flush with an outer surface of the hull.

The port water inlet port and the port water intake scoop may be located on the bottom wall of the hull near the stern of the hull; and the starboard water inlet port and the starboard water intake scoop may be located on the bottom wall of the hull near the stern of the hull.

The port water inlet port and the port water intake scoop may be located on the port side wall of the hull near the stern of the hull; and the starboard water inlet port and the starboard water intake scoop may be located on the starboard side wall of the hull near the stern of the hull.

When in the active position the port intake scoop and the starboard intake scoop may be positioned at an angle relative the side wall of the hull in a range of from about 20° to about 70°.

In another embodiment, the port water intake scoop may be slidably mounted to the hull adjacent a rearward side of the port water inlet port, and the port actuator selectively translates the port water intake scoop between the inactive position and the active position; and the starboard water intake scoop may be slidably mounted to the hull adjacent a rearward side of the starboard water inlet port, and the starboard selectively translates the starboard water intake scoop between the open and closed positions.

The port water inlet port and the port water intake scoop may be located on the bottom wall of the hull near the stern of the hull; and the starboard water inlet port and the starboard water intake scoop may be located on the bottom wall of the hull near the stern of the hull.

A second port water inlet port and a second port water intake scoop may be located on the port side wall of the hull, with the first end of the port water conduit in communication with the second port water inlet port; and a second starboard water inlet port and a second starboard water intake scoop may be located on the starboard side wall of the hull, with the first end of the starboard water conduit in communication with the second starboard water inlet port.

The port water inlet port and the port water intake scoop may be located on the port side wall of the hull near the stern of the hull; and the starboard water inlet port and the starboard water intake scoop may be located on the starboard side wall of the hull near the stern of the hull.

In other embodiments there is provided a wave shaping device for a boat, the boat comprising a hull, the hull having a bow, a port sidewall, a starboard sidewall, a bottom wall and a stern wall, the bottom wall and the side walls converging from the rear wall to generally converge at the bow; a propulsion system for propelling the boat forward, the wave shaping device comprising: a water inlet port in the hull adjacent the stern wall of the boat toward a first side of the boat relative to center and below the water line when the boat is floating; a water outlet in the hull toward a second side of the boat opposite the first side; a water conduit inside the hull having a first end in communication with the water inlet port and a second end in communication with the water outlet; a water intake scoop that is selectively movable between a) an inactive position in which the starboard water intake scoop does not extend beyond the side walls or bottom wall of the hull and b) an active position in which the starboard water intake scoop extends beyond one of a side wall and bottom wall of the hull, whereby the starboard intake scoop directs ambient water into the starboard water inlet port, through the water conduit and out the water outlet as the boat moves forward through the water; and an actuator for moving the intake scoop between the closed position and the open position.

Other embodiments of the present disclosure provide a wave shaping device for a boat, the boat having a hull, the hull having a bow, a port sidewall, a starboard sidewall, a bottom wall and a stern wall, the bottom wall and the side walls extend forwardly from the rear wall, forward portions of the side walls generally converge at the bow; a jet propulsion system having a forward facing water intake opening in the bottom wall of the hull for receiving ambient water when the boat is floating, a jet propulsion unit for receiving water from the intake opening and accelerating the water, and a jet nozzle for receiving the accelerated water from the jet propulsion unit and emitting a water jet in a rearward direction relative to the boat for propelling the boat forward, the wave shaping device comprising: a water inlet port in the hull of the boat toward a first side of the boat located below the water line when the boat is floating; a water conduit inside the hull, a first end of the water conduit in communication with the water inlet port and a second end of the port water conduit in communication with the water intake opening of the jet propulsion system for directing ambient water from the port water inlet port to the water intake opening; an intake scoop that is selectively movable between a) an inactive position in which the water intake scoop does not extend beyond the side walls or bottom wall of the hull and b) an active position in which the water intake scoop extends beyond one of a side wall and bottom wall of the hull, whereby the water intake scoop directs ambient water into the water inlet port as the boat moves forward through the water; and an actuator for selectively moving the intake scoop between the inactive position and the active position.

Further embodiments of the present disclosure provide a method of shaping a wake produced by a boat, the boat having a hull, the hull having a bow, a port sidewall, a starboard sidewall, a bottom wall and a stern wall, the bottom wall and the side walls extend forwardly from the rear wall, forward portions of the side walls generally converge at the bow; a jet propulsion system having a forward facing water intake opening in the bottom wall of the hull for receiving ambient water when the boat is floating, a jet propulsion unit for receiving water from the intake opening and accelerating the water, and a jet nozzle for receiving the accelerated water from the jet propulsion unit and emitting a water jet in a rearward direction relative to the boat for propelling the boat forward, the wave shaping method comprising: selectively directing ambient water one of 1) from the port side of the boat to the water intake of the jet propulsion system and 2) from the starboard side of the boat to the water intake of the jet propulsion system.

The method may include providing a port water inlet port in the hull of the boat on the port side portion of the boat located below the water line when the boat is floating; providing a port water conduit inside the hull, a first end of the port water conduit in communication with the port water inlet port and a second end of the port water conduit in communication with the water intake opening of the jet propulsion system for directing ambient water from the port water inlet port to the water intake opening; providing a port intake scoop that is selectively movable between a) an inactive position in which the port water intake scoop does not extend beyond the side walls or bottom wall of the hull and b) an active position in which the port water intake scoop extends beyond one of a side wall and bottom wall of the hull, whereby the port intake scoop directs ambient water into the port water inlet port as the boat moves forward through the water; providing a port actuator for selectively moving the port intake scoop between the inactive position and the active position; providing a starboard water inlet port in the hull of the boat on the starboard side portion of the boat located below the water line when the boat is floating; providing a starboard water conduit inside the hull, a first end of the starboard water conduit in communication with the starboard water inlet port and a second end of the starboard water conduit in communication with the water intake of the jet propulsion system for directing ambient water from the starboard water inlet port to the water intake opening; providing a starboard intake scoop that is selectively movable between a) an inactive position in which the starboard water intake scoop does not extend beyond the side walls or bottom wall of the hull and b) an active position in which the starboard water intake scoop extends beyond one of a side wall and bottom wall of the hull, whereby the starboard intake scoop directs ambient water into the starboard water inlet port as the boat moves forward through the water; and providing a starboard actuator for selectively moving the starboard intake scoop between the inactive position and the active position; wherein the step of selectively redirecting water comprises, selectively one of: moving the port intake scoop to the active position while retaining the starboard intake scoop in the inactive position, thereby redirecting water from the port side of the boat to the water intake of the jet propulsion system; and moving the starboard intake scoop to the active position while retaining the port intake scoop in the inactive position, thereby redirecting water from the port side of the boat to the water intake of the jet propulsion system.

Other methods of the present disclosure may include the step of maintain the port side water intake scoop and the starboard side water intake scoop in the inactive position when traveling at speeds greater than about 15 mph.

The port water inlet port and the port water intake scoop are provided on the bottom wall of the hull near the stern of the hull; and the starboard water inlet port and the starboard water intake scoop are provided on the bottom wall of the hull near the stern of the hull.

The methods disclosed herein may include providing a second port water inlet port and a second port water intake scoop located on the port side wall of the hull, with the first end of the port water conduit in communication with the second port water inlet port; and a second starboard water inlet port and a second starboard water intake scoop located on the starboard side wall of the hull, with the first end of the starboard water conduit in communication with the second starboard water inlet port.

The port water inlet port and the port water intake scoop may be provided on the port side wall of the hull near the stern of the hull; and the starboard water inlet port and the starboard water intake scoop may be provided on the starboard side wall of the hull near the stern of the hull.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is perspective rear view of a boat with a Prior Art wave shaping system.

FIG. 2 is a perspective rear view of a boat with a Prior Art wave shaping system.

FIGS. 3A and 3B are diagrammatic top views of the stern of a boat with a Prior Art wave shaping system.

FIG. 4 is a side view of a wake boat including a wake shaping system according to one embodiment of the present disclosure.

FIG. 5 is a diagrammatic bottom view of a wake boat including a wake shaping system as illustrated in FIG. 4.

FIG. 6 is a side view of a wake boat including a wake shaping system according to another embodiment of the present disclosure.

FIG. 7 is a diagrammatic bottom view of a wake boat including a wake shaping system as illustrated in FIG. 6.

FIG. 8 is a diagrammatic bottom view of a wake boat including a wake shaping system according to a further embodiment of the present disclosure.

FIG. 9 is a diagrammatic bottom view of a wake boat including a wake shaping system according to a further embodiment of the present disclosure.

FIG. 10 is a diagrammatic side view of stern portion of a wake boat including a wake shaping system according to a further embodiment of the present disclosure.

FIG. 11 is a diagrammatic side view of stern portion of a wake boat including a wake shaping system according to a further embodiment of the present disclosure.

FIG. 12 is a diagrammatic bottom view of a wake boat including a wake shaping system according to a further embodiment of the present disclosure.

FIG. 13 is a diagrammatic bottom view of a wake boat including a wake shaping system according to a further embodiment of the present disclosure.

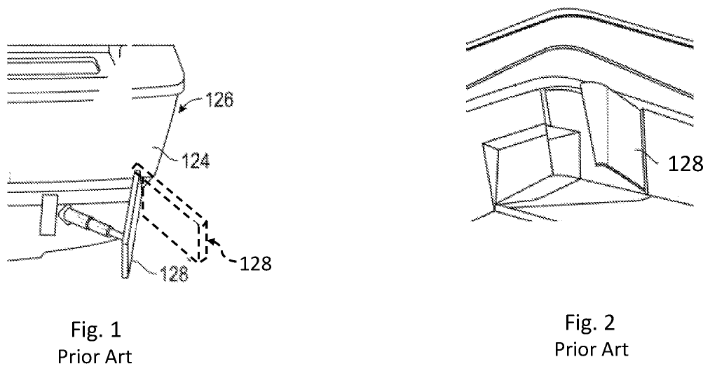

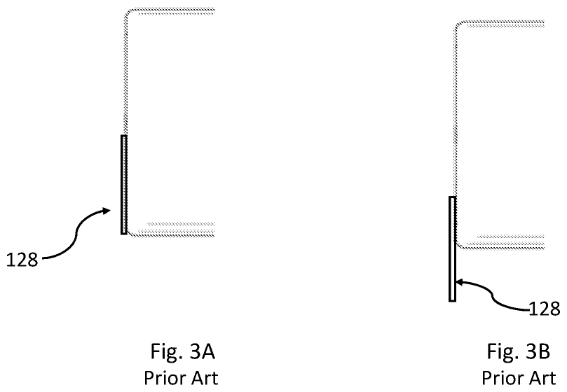

### DETAILED DESCRIPTION OF THE DISCLOSURE

To facilitate the understanding of this disclosure, a number of marine terms are defined below. Terms defined herein have meanings as commonly understood by a person of ordinary skill in the areas relevant to the present disclosure. Bow” refers generally to the front of the boat. “Transom” and “stern” refer generally to the rear of the boat. “Starboard” refers to the right-hand, or driver's, side of the boat when facing the bow. “Port” refers to the left-hand, or passenger's, side of the boat when facing the bow. “Forward” means toward the bow. “Rearward” means toward the stern. According the present disclosure, the “center” or “centerline” of the boat is a line down the center of the boat, from the bow to the stern that separates the boat into a port half and a starboard half “Toward the port side of the boat” means anywhere on the port half/side of the boat. “Toward the starboard side of the boat” means anywhere on the starboard half/side of the boat. Terms such as “a”, “an”, and “the” are not intended to refer to only a singular entity, but include the general class of which a specific example may be used for illustration. The terminology herein is used to describe specific embodiments of the disclosure, but their usage does not limit the disclosure, except as outlined in the claims.

Various embodiments of a wake shaping device for a boat are described herein. It is to be understood, however, that the following explanation is merely exemplary in describing the devices and methods of the present disclosure. Accordingly, several modifications, changes, and substitutions are contemplated.

As a boat travels through water, the hull of the boat displaces water both downwardly from the bottom of the boat and outwardly from the sides of boat, creating a cavity behind the transom of the boat. The displaced water then re-converges behind the boat, filling the cavity behind the transom, and creating a wave at a point of convergence. The wave extends from the point of convergence in a V-shape, creating wakes behind the boat that are suitable for wake boarding or wake surfing. Because of known principles of fluid dynamics, the port side of the boat displaces water that creates the starboard wake past the point of convergence and the starboard side of the boat displaces water that creates the port wake past the point of convergence.

Wakeboard boat hulls are specifically designed with a running surface that shapes wakes to make optimum wake boarding wakes that are large, firm, and symmetrical on both sides behind the boat at wake boarding speeds and rope lengths, i.e., approximately 50 to 80 feet behind the boat when the boat is travelling between 18 and 25 mph. Therefore, wakeboard boat manufacturers do not want to change the running surface of the hull at wakeboard speeds in order to maintain optimum wakeboard wakes for wakeboarders.

In order to surf behind a wakeboard boat, however, the convergence point is delayed on one side, creating a large, curling, and asymmetrical wake behind the boat at wake surfing speeds and rope lengths, i.e., approximately 5 and 20 feet behind the boat when the boat is travelling between 5 and 15 mph, or 8 mph to 12 mph. According the present disclosure, in order to delay the convergence point on one side, the running surface of the boat and flow of water past the boat is manipulated. In order to create a left-side, or port, wakesurf wake, a starboard wake shaping device may be used to manipulate the flow of water past the starboard side of the boat, thereby creating a larger cavity on the starboard side of the boat, delaying the convergence point on the starboard side and shifting it starboard, and therefore creating a smoother port side wakesurf wake beyond the convergence point that is optimized for left-side wake surfing. Conversely, in order to create a right-side, or starboard, wakesurf wake, a port wake shaping device may be used to manipulate the flow of water past the port side of the boat, delaying the convergence point on the port side and shifting it port, therefore creating a smoother starboard wakesurf wake beyond the convergence point that is optimized for starboard side wake surfing.

Professional athletes, recreational purists, and families often want to cruise, wakeboard, water ski and wakesurf on the same days behind the same boat and in back-to-back sets. Therefore, any wake shaping device mounted to the transom or hull of the boat should, when not activated for wake surfing, remain fully within the cavity behind the transom of the boat or flush with the bottom or side surfaces of the hull, as the case may be, so as not to change the running surface of the hull while cruising, wake boarding or waterskiing. When activated for wake surfing at relatively slow wakesurfing speeds, the wake shaping device is extended out from the hull of the boat to manipulate the flow of water on one side of the boat, and therefore create the desired asymmetrical wakesurf wakes.

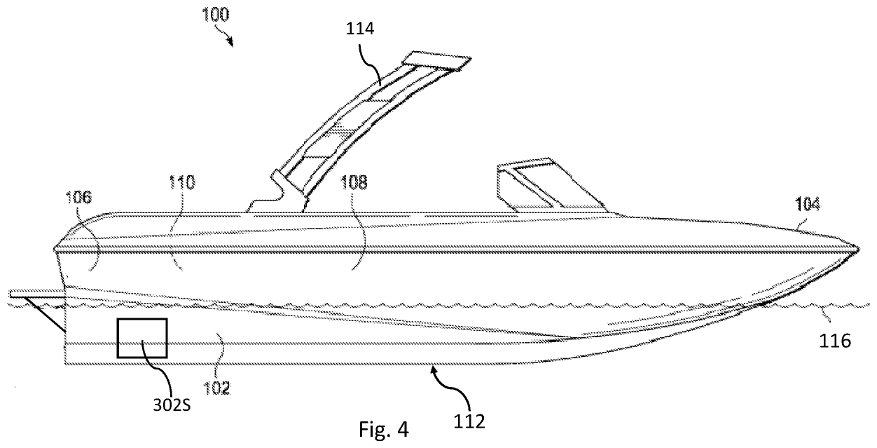

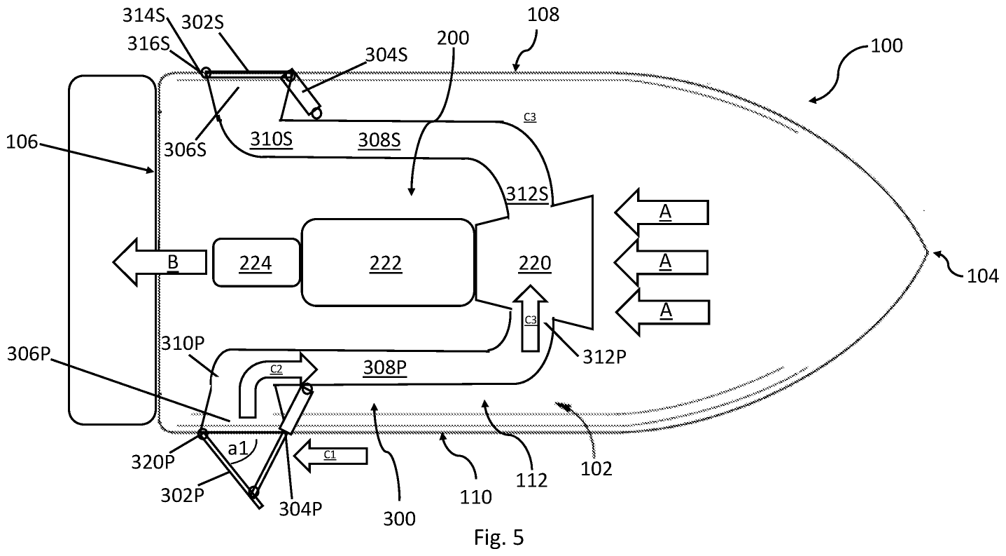

FIG. 4 diagrammatically illustrates a starboard side view of a boat and FIG. 5 diagrammatically illustrates a starboard side view of a boat 100 having a wake shaping system in accordance with one embodiment of the present disclosure. The boat 100 includes a hull 102 with a bow 104, a transom/stern wall 106, a starboard side wall 108, a port side wall 110 and a bottom wall 112 (see FIG. 2). The boat 100 may be a wakeboard boat having an inboard motor and V-drive transmission, an internal ballast system, and an elevated tow point, or tower 114, for attaching a rope for pulling a wake boarder or wake surfer by the boat. However, in other embodiments of the present disclosure, the boat 100 may be a direct drive inboard boat, a stern drive inboard/outboard (I/O) boat, an inboard jet drive boat or an outboard jet boat. In other embodiments, as illustrated in FIGS. 5 and 5. The boat may or may not include an internal ballast system (not shown).

According to one form of the present disclosure, the boat may include an inboard jet propulsion system 200. The jet propulsion system 200 may include a water intake opening 220 in the bottom of the hull 102, a motor and water jet pump mechanism 222 inside the hull, and a directional water jet nozzle 224 outside the hull. Jet propulsion systems are well known in the art. As such, the water intake 220 water jet pump and the directional water jet nozzle are not described in detail herein. The jet pump 222 draws ambient water (arrows A) in through the water intake 220, the water is accelerated by the converging sides of the water intake and directed into the jet pump 222. The jet pump further accelerates the water and the water is then directed through the directional water jet nozzle 224 and emitted as a water jet directed toward the stern of the boat (arrow B) to create thrust that drives the boat forward. As is well understood in the art, the water jet nozzle is gimballed (not shown) such that it may be pivoted from left to right (from port to starboard) for turning/steering the boat, and up and down for adjusting the trim of the boat. It will be appreciated that any known type of water jet propulsion system may be employed with the wake shaping system of the present disclosure, including both inboard, outboard or other style jet propulsion systems.

As best seen in FIG. 5, the boat 100 may include a wake shaping system 300. On the starboard side of the boat, the wake shaping system may include a starboard water intake baffle or water intake scoop 302S mounted to the starboard side wall 108 of the hull adjacent the stern 106 of the hull 102 and below a waterline 116 (see FIG. 4) when the boat 100 is floating. The wake shaping system also may include a starboard actuator 304S, such as a hydraulic cylinder, for manipulating the starboard intake scoop 302S, a starboard water inlet port 306S in the starboard side of the hull (behind/under the starboard intake scoop), and a starboard water conduit 308S inside the hull of the boat. A first end 310S of the starboard water conduit 308S communicates with the starboard water inlet port 306S and a second end 312S of the starboard water conduit communicates with the water intake 220 of the jet propulsion system. A rear (stern side) edge 314S of the starboard intake scoop 302S is pivotally attached 316S to the hull adjacent to the rear edge (stern side) 314S of the starboard water inlet port. The starboard actuator is connected between the hull and a forward portion of the starboard intake scoop, whereby the starboard actuator 304S may be actuated to pivot the starboard intake scoop between a) a closed/retracted/inactive position (as illustrated in FIGS. 4 and 5) and b) an open/extended/active position (see port intake scoop 302P in FIG. 5). The port side of the boat 100 may similarly be provided with a port water intake scoop 302P, a port actuator 304P, such as a hydraulic cylinder, a port water inlet port 306P, and a port water conduit 308P inside the hull of the boat. The port water conduit 308P communicates the port water inlet port 306P with the water intake 220 of the jet propulsion system. The port intake scoop 302S is illustrated in FIG. 5 in the open/extended/active position.

In operation, the starboard and port water intake scoops 302S and 302P may be maintained in the closed position for normal driving/cruising, water skiing, wake boarding and any other relatively high-speed speed activity that is performed at a speed over about 15 mph or over about 20 mph. In the closed/inactive position, the intake scoops 302S and 302P close and seal the water inlet ports 306 (306P and 306S). The outer surfaces of the intake scoops may be flush with the external surface of the hull when in the retracted/inactivated position so as not to spoil or change the hydrodynamics of the hull.

When it is desired to wakesurf, while the boat is stopped or moving very slowly, one of the port or starboard actuators 304P and 304S is activated to move a corresponding one of the intake scoops 302P and 302S to the open/activated position, i.e., the wake surfing position. For example, as illustrated in FIG. 5, the port actuator 304P is activated to move the port intake scoop 302 to the open/active position for starboard side wake surfing, while the starboard water intake scoop is maintained in the closed position. 5. When in the open position, the port intake scoop 302P redirects/scoops ambient water moving past the port side of the hull (arrow C1) as the boat is propelled forward and redirects the water through the port water inlet port 306P in the hull. Water pressure created by the water C1 colliding with the intake scoop pushes the water through the inlet port 306P, into the first end 310P of the port water conduit 308P, through the water conduit 308P (arrow C2), out the second end 312P of the water conduit and into the water intake 220 of the jet propulsion system (arrow C3). When in the open activated positions, intake scoops 302P and 302S may be positioned at an acute angle a1 to the side wall of the hull (or relative to the forward direction of travel of the boat), in order to redirect the ambient water C1 into the water inlet ports 306P and 306S as the boat moves through the water. Angle a1 between the intake scoop and the side wall of the hull may be any angle greater than 0° to about 90°; from about 20° to about 70°, or from about 30° to about 60°. The jet propulsion system also acts to suck water in through the water inlet port 306P via the water conduit 308P. By redirecting water moving past the port side of the boat into the jet propulsion system, the port intake scoop 302P creates a larger cavity behind the boat on the port side of the boat, delaying the convergence point on the port side and shifting it toward port, and therefore creating a larger wakesurf wake that is optimized for starboard side wake surfing.

It will be appreciated that for port side wake surfing, the starboard actuator 304S is activated to move the starboard intake scoop 302S to the open/activated position, while the port intake scoop 302P is maintained in the closed position. When it is desired to once again travel at higher speeds for cruising, wake boarding, water skiing or other activity, both the port and starboard intake scoops are moved to and maintained in the closed positions, flush with the surface of the hull.

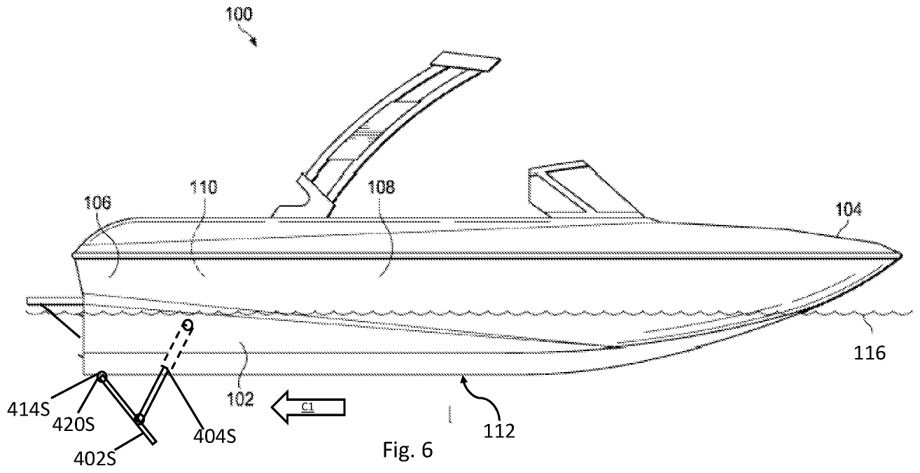

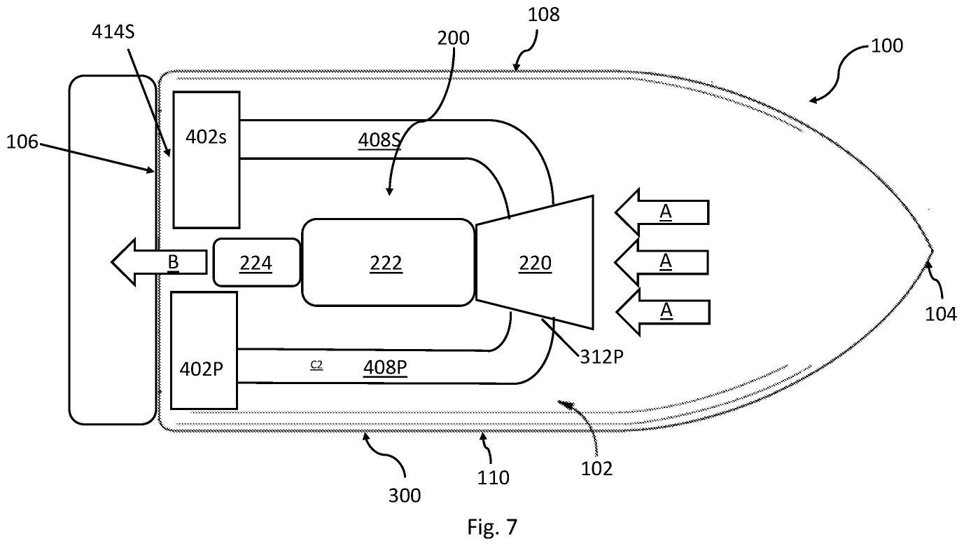

In another embodiment of a wake shaping system of the present invention diagrammatically illustrated in FIG. 6 (starboard side view) and FIG. 7 (bottom view), the intake scoops and water inlet ports may be located on the bottom wall 112 of the hull. Similar to the embodiment of FIGS. 4 and 5, the wake shaping system according to this embodiment may include a starboard water intake baffle or scoop 402S (located in the bottom of hull, adjacent the stern wall 106 of hull, and on the starboard side of the hull), a starboard actuator 404S, such as a hydraulic cylinder, for moving/activating the starboard intake scoop, a starboard water inlet port (not shown) in bottom of the hull behind the starboard intake scoop, and a starboard water conduit 408S inside the hull of that communicates the starboard water inlet port with the water intake 220 of the jet propulsion system. A rear (stern side) edge 414S of the starboard intake scoop 402S is pivotally attached to the hull adjacent to the rear (stern side) of the starboard water inlet port, whereby the starboard actuator 404S may be actuated to pivot the intake scoop between a) a closed/retracted/inactive position and b) an open/extended/active position to scoop water from the starboard side of the boat to direct the water into the intake 220 of the jet propulsion system. The starboard intake scoop 402S is illustrated in FIG. 6 in the open or activated position. The port side of the boat 100 may similarly be provided with a port water intake scoop 402P, port actuator not shown), port water inlet port (not shown), and port water conduit 408P inside the hull of the boat that communicates the port water inlet port with the water intake 220 of the jet propulsion system. Operation of the embodiment of the wake shaping system of FIGS. 6 and 7 is substantially the same as the operation of the wake shaping system of FIGS. 4 and 5 described above.

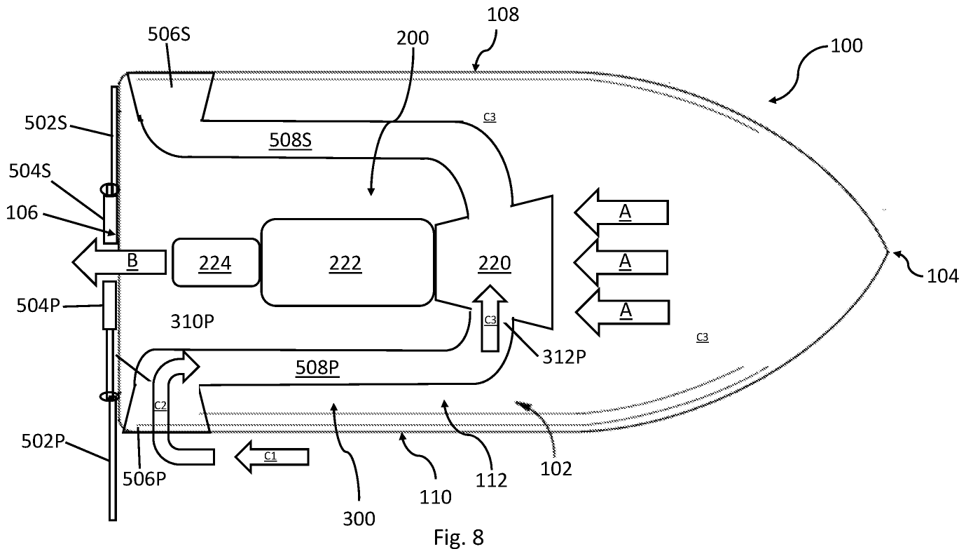

Another embodiment of a wake shaping system of the present disclosure is diagrammatically illustrated in FIG. 8 (bottom view). In this embodiment, the water inlet ports 506S and 506P may be located on side walls 108, 110 of the hull, similar to the embodiment of FIGS. 4 and 5. In this embodiment, however, the water intake scoops 502P and 502S may be generally flat plates mounted on slides (not shown) on the outer surface of the stern wall 106 of the hull the for translational movement between the retracted/inactivated position (see starboard intake scoop 502S) and the extended/activated position (see port intake scoop 502P). Similar to other embodiments hereof, this system may include a starboard actuator 504S for moving/activating the starboard intake scoop, a starboard water inlet port 506S in the starboard side wall of the hull near the stern, and a starboard water conduit 508S inside the hull that communicates the starboard water inlet port with the water intake 220 of the jet propulsion system 200. The starboard intake scoop 502S is illustrated in the retracted/inactivated position. The port side 110 of the boat 100 may similarly be provided with a port water intake scoop 502P, port actuator 504P, port water inlet port 506P, and port water conduit 508P inside the hull of the boat that communicates the port water inlet port with the water intake 220 of the jet propulsion system. The port water intake scoop 502P is illustrated in the extended/activated position, so that water is redirected by the port intake scoop into the port water inlet port and into the water conduit as illustrated by arrow C2. When in the inactivated position, the port and starboard intake scoops may be located entirely behind the stern wall of the boat so as not to disturb the flow of water over the hull during relatively high-speed activities. Operation of the embodiment of the wake shaping system of FIG. 8 is substantially the same as the operation of the wake shaping system of FIGS. 4 and 5 described above.

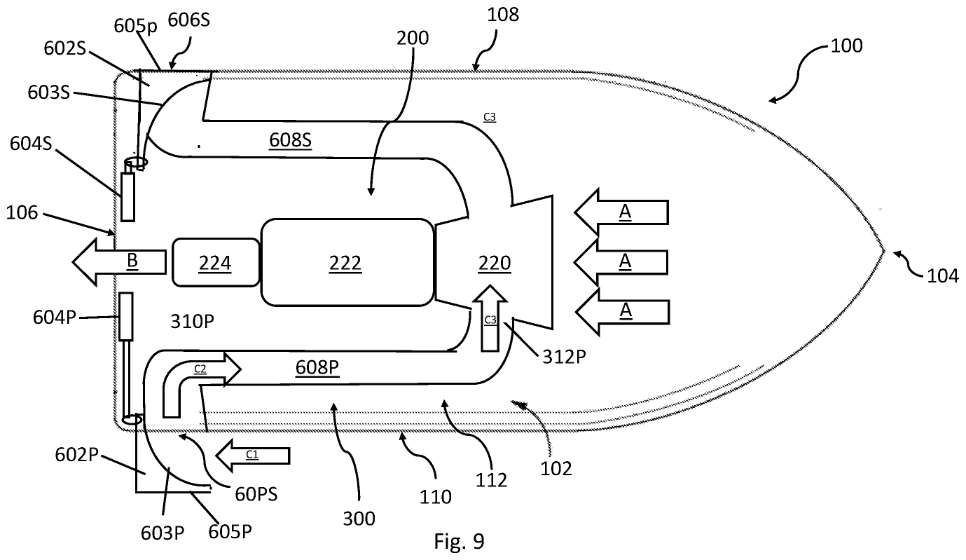

Another embodiment of a wake shaping system of the present disclosure is diagrammatically illustrated in FIG. 9 (bottom view). In this embodiment the water inlet ports 606S and 606P may be located in the side walls of the hull and the water intake scoops 602P and 602S may be mounted to the hull on slides (not shown) for translational movement between the retracted/closed/inactivated position (see starboard intake scoop 602S) and the extended/open/activated position (see port intake scoop 602P). However, in this embodiment, the water intake scoops 602P and 602S are located inside the hull when in the retracted/closed/inactivated position and extend out the side wall of the hull when in the extended/open/activated position. The water intake scoops 602P and 602S of this embodiment have concave forward facing water scooping surfaces 603P and 603S for smoothly scooping and redirecting the water into the water inlet ports 606P and 606S when in the activated position (see starboard intake scoop 602S). Intake scoops 602P and 602S have outer surfaces 605P and 605S that are flush with the exterior surface of the hull when in the closed/inactivated positions so as not to disturb the flow of water over the hull of the boat during relatively high-speed activities.

Similar to other embodiments, this system may include a starboard actuator 604S for moving/activating the starboard water intake scoop 602S, a starboard water inlet port 606S in the starboard side wall of the hull near the stern, and a starboard water conduit 608S inside the hull that communicates the starboard water inlet port with the water intake 220 of the jet propulsion system 200. The starboard intake scoop 602S is illustrated in FIG. 8 in the closed or inactivated position. The port side 110 of the boat 100 may similarly be provided with a port water intake scoop 602P, port actuator 604P, port water inlet port 606P, and port water conduit 608P inside the hull of the boat that communicates the port water inlet port with the water intake 220 of the jet propulsion system. The port water intake scoop 602P is illustrated in FIG. 8 in the retracted/closed/inactivated position. Operation of the embodiment of the wake shaping system of FIG. 9 is substantially the same as the operation of the wake shaping system of FIGS. 4 and 5 described above.

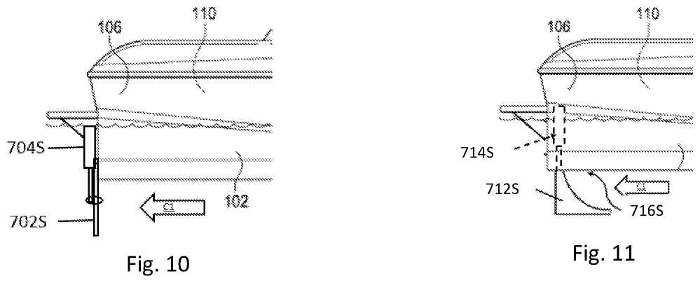

It will be appreciated that intake scoops as substantially described and illustrated in FIGS. 8 and 9 may be utilized in configurations in which the water inlet ports are located in the bottom wall of the hull. As illustrated in FIG. 10 a generally flat water intake scoop 702S may be slidably mounted to the stern of the boat and an actuator 704S may be employed to translate the water intake scoop 702S between the retracted/inactivated position and the extended/activated position as illustrated. Similarly, as illustrated in FIG. 11, an intake scoop 712S with a concavely curved water scooping/active surface substantially described in relation to FIG. 9 may be mounted to extend from the bottom of the hull to open and close a water inlet port 716S in the bottom wall of the hull. The rest of the wave shaping systems and the operation thereof are substantially the same as described in relation to FIGS. 6 and 7, e.g., with port and starboard wave shaping systems.

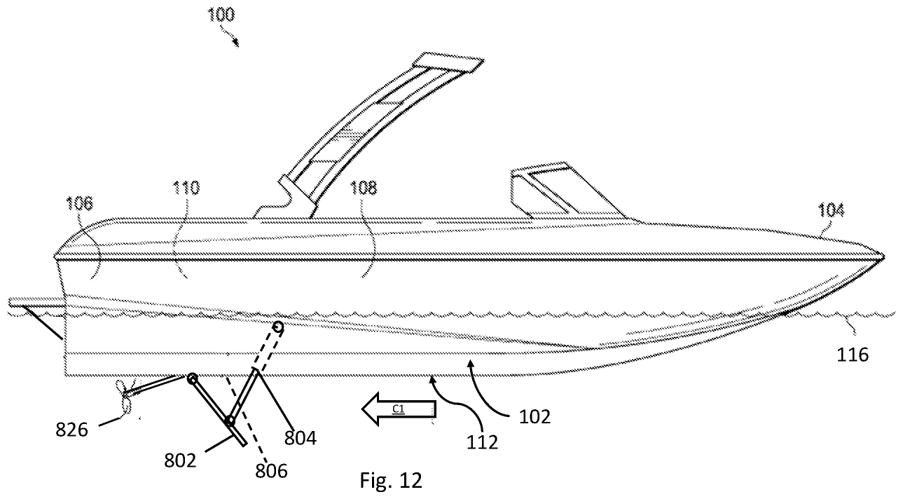

Wave shaping systems as described in all of the embodiments contained herein may be employed in boats that do not have a jet propulsion system, but instead have some other style of jet propulsion system, such as any well-known propellor type propulsion system (not shown). By way of example, as diagrammatically illustrated in FIG. 12 (side view), the boat may be an inboard motor propeller driven boat with a propeller 826 located in the water under the hull 112. A water inlet port (not illustrated) may be located in the bottom wall of the hull in front of the propeller 826. A water intake scoop 802 and an actuator 804 may also be provided for opening and closing the water inlet port as described previously herein. A water conduit (not shown) may be located inside the hull. The water conduit may have a first end in communication with the water inlet port and a second end in communication with a water outlet port in the hull (not shown) toward one side of the boat. Alternatively, the water conduit may be bifurcated, having a first branch that leads to a port water outlet port in the hull (not shown) toward the port side of the boat and a second branch that leads to a starboard water outlet port (not shown) in the hull toward the starboard side of the boat. A valve or vane bay be provided at the bifurcation in the water conduit for selectively directing the water to the first branch or to the second branch of the water conduit. It will be appreciated that the water outlet ports may be located in the bottom wall of the hull, the stern wall of the hull or the side wall(s) of the hull.

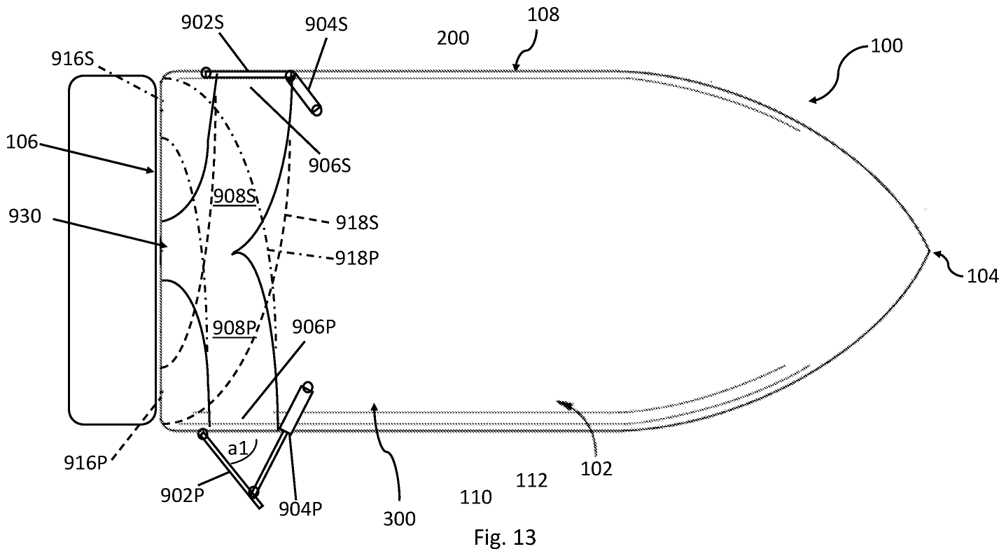

Another exemplary embodiment of a boat with propeller propulsion system having a wave shaping system of the present disclosure is diagrammatically illustrated in FIG. 13. In this embodiment a wave shaping system may be provided that has port and starboard water intake scoops 902P and 902S, port and starboard water inlet ports 906P and 906S, port and starboard actuators 904P and 904S, and a water outlet 930 in the stern wall or bottom wall of the hull. Port and starboard water conduits 908P and 908S communicate the water the water inlet ports with the water outlet. In this embodiment water is selectively redirected from one side of the boat to the center of the boat to shape the wave as described herein. In variations of this embodiment (as illustrated in dashed lines), the port water conduit 918P (dash-dot lines) may communicate the port water inlet port with a starboard water outlet port 916S toward the starboard side of the boat, e.g., on a starboard side of a centerline of the boat that divides the boat into a starboard side and a port side. While, the starboard water conduit 918S (dash-dash lines) may communicate the starboard water inlet port 916P with a port water outlet port toward the port side of the boat, e.g., on a port side of a centerline of the boat. The port water outlet port and the starboard water outlet port may be located in any one or more of the stern wall of the hull, the bottom wall of the hull or the side walls of the hull.

In further embodiments of the present disclosure, there may be both a) a port and starboard pair intake ports and intake scoops in the side walls of the hull and b) a port and starboard pair of intake ports and intake scoops in the bottom wall of the hull, as shown and described in the previous embodiments. For port side wake surfing any one of a) just the starboard intake scoop on the side wall of the hull may be opened/activated, b) just the starboard intake scoop on the bottom wall of the hull may be opened/activated, or c) both the starboard intake scoop on the side wall of the hull and the starboard intake scoop on the bottom wall of the hull may be opened/activated. Similarly, for starboard side wake surfing any one of a) just the port intake scoop on the side wall of the hull may be opened, b) just the port intake scoop on the bottom wall of the hull may be opened, or c) both the port intake scoop on the side wall of the hull and the port intake scoop on the bottom wall of the hull may be opened.

The intake baffles of the embodiments of FIGS. 4-8, 10, 12 and 13 have been illustrated and described as generally flat plates. It will be appreciated that, unless expressly stated otherwise, the intake baffles in each the embodiments hereof may take any suitable shape. For example, an active/water scooping surface of the intake baffles (the forward-facing surface that deflects the water) may be smoothly curved in manner to optimize the flow of water. For example, the active surface of the intake baffles may be a smoothly curving concave surface that smoothly guides/redirects the water into the water inlet port. The curvature of the active surface may be in one direction only, or two directions, such that the active surface of the intake opening is generally clam shell shaped. Curvature of the active surface may also vary. For example, the curvature of the active surface may start with a relatively large radius furthest from the water inlet port and increase to a smaller radius closest to the water inlet port, e.g. similar to a parabolic curve. It will also be appreciated that the active surface of the intake baffles may be designed to be aligned and flush with the inner surface of the water inlet ports for smooth transitioning of water from the intake ports and through the water inlet port. Similarly, the active surface of the intake scoop, the inner surface of the water inlet port and the inner surface of the water conduit may all be designed to be aligned and flush with each other, so that together they form a contiguous smoothly curving surface(s) for optimized flow of water from the intake scoops, through the water inlet ports, through water conduit and into the water intake of the jet propulsion system.

As previously described herein, the water conduits in the boats may communicate the water inlet ports in the hull of boat with the water intake of the jet propulsion system. As a result of suction created by the jet propulsion system at the water intake of the jet propulsion system, water is suctioned from the area in front of the intake scoop via the water conduit and the water inlet port. Suction of water from in front of the intake scoop by the jet propulsion system serves to reduce the pressure created in the water in front of the inlet baffle by the movement of the water past the and into the intake baffle, which in turn reduces the torque and drag created on the boat by the intake scoop when it is extended into the active wake surfing position. This reduces the need for the drive to compensate for the torque by counter steering, thereby making the boat easier and safer to steer and improving fuel economy when wake surfing.

A closure plate may be provided on the water intake into the jet propulsion system (not shown) and an actuator may be provided for selectively moving the closure plate to optionally partially or entirely close the water intake 220 and reduce or stop the intake of ambient water from under the boat when wake surfing or open the water intake to allow water to enter the jet propulsion system via the water intake. Closing the water intake causes all of the water being driven through the jet propulsion system to be drawn through the open water inlet port from the area in front of the open intake scoop. In this manner, the amount of water being diverted from one side of the boat can be maximized, in order to maximize the size of the cavity formed on that side of the boat and maximize the size of the wake surfing wave produced on the other side of the boat. This also serves to remove more water from in front of the intake scoop, thereby reducing the torque created and making the boat easier and safer to steer during wake surfing. This also reduces the overall drag created by the intake scoop and provides better fuel economy.

It is believed that by redirecting water from a first side of the boat and one of into the jet propulsion system, to the center of the boat or to the opposite/second side of the boat, the wake forming system of the present disclosure increases the size of the cavity formed in the water behind the boat on the first side of boat and decreases the size of the cavity formed in the water behind the boat on a second side of the boat, thereby shaping the wave behind the boat for wake surfing on the second side of the boat.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. For example, hydraulic cylinders are disclosed as the actuators for moving the water intake scoops from the inactivated to the activated positions. It will be appreciated that any type of suitable actuator may be employed move the intake scoops. For example, mechanical (screw, rack and pinion, etc.) magnetic, pneumatic or electronic actuators may be employed in place of hydraulic cylinder actuators. Moreover, it will be appreciated that any type of propeller, such as a ducted propeller may be employed with the propeller embodiments of the present disclosure. As such, the term “propeller” should be interpreted broadly in the claims.

Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A wave shaping device for a boat, the boat comprising a hull, the hull having a bow, a port sidewall, a starboard sidewall, a bottom wall and a stern wall, the bottom wall and the side walls extend forwardly from the rear wall, forward portions of the side walls generally converge at the bow; a jet propulsion system having a forward facing water intake opening in the bottom wall of the hull for receiving ambient water when the boat is floating, a jet propulsion unit for receiving water from the intake opening and accelerating the water, and a jet nozzle for receiving the accelerated water from the jet propulsion unit and emitting a water jet in a rearward direction relative to the boat for propelling the boat forward, the wave shaping device comprising:
a. a port water inlet port in the hull of the boat on the port side portion of the boat located below the water line when the boat is floating;
b. a port water conduit inside the hull, a first end of the port water conduit in communication with the port water inlet port and a second end of the port water conduit in communication with the water intake opening of the jet propulsion system for directing ambient water from the port water inlet port to the water intake opening;
c. a port intake scoop that is selectively movable between a) an inactive position in which the port water intake scoop does not extend beyond the side walls or bottom wall of the hull and b) an active position in which the port water intake scoop extends beyond one of a side wall and bottom wall of the hull, whereby the port intake scoop directs ambient water into the port water inlet port as the boat moves forward through the water;
d. a port actuator for selectively moving the port intake scoop between the inactive position and the active position;
e. a starboard water inlet port in the hull of the boat on the starboard side portion of the boat located below the water line when the boat is floating;
f. a starboard water conduit inside the hull, a first end of the starboard water conduit in communication with the starboard water inlet port and a second end of the starboard water conduit in communication with the water intake of the jet propulsion system for directing ambient water from the starboard water inlet port to the water intake opening;
g. a starboard intake scoop that is selectively movable between a) an inactive position in which the starboard water intake scoop does not extend beyond the side walls or bottom wall of the hull and b) an active position in which the starboard water intake scoop extends beyond one of a side wall and bottom wall of the hull, whereby the starboard intake scoop directs ambient water into the starboard water inlet port as the boat moves forward through the water; and
h. a starboard actuator for selectively moving the starboard intake scoop between the inactive position and the active position.

2. A wave shaping device for a boat as in claim 1, wherein:
a. a rearward edge of the port water intake scoop is pivotally connected to the hull adjacent a rearward side of the port water inlet port, and the port actuator extends between the hull and a forward portion of the port water intake scoop for pivoting the port water intake scoop between the inactive position and the active position; and
b. a rearward edge of the starboard water intake scoop is pivotally connected to the hull adjacent a rearward side of the starboard water inlet port, and the starboard actuator extends between the hull and a forward portion of the starboard water intake scoop for pivoting the starboard water intake scoop between the inactive position and the active position.

3. A wave shaping device as in claim 2, wherein:
a. the port intake scoop covers the port water inlet port when in the inactive position; and
b. the starboard intake scoop covers the starboard water inlet port when in the inactive position.

4. A wave shaping device as in claim 2, wherein a forward-facing surface of the port water intake scoop when in the active position is a concave surface configured to smoothly redirect ambient water into the port water inlet port, and a forward facing surface of the starboard water intake scoop when in the active position is a concave surface configured to smoothly redirect ambient water into the starboard water inlet port.

5. A wave shaping device as in claim 2, wherein an outer surface of the port water intake scoop when in the inactive position is flush with an outer surface of the hull and an outer surface of the starboard water intake scoop when in the inactive position is flush with an outer surface of the hull.

6. A wave shaping device for a boat as in claim 2, wherein:
a. the port water inlet port and the port water intake scoop are located on the bottom wall of the hull near the stern of the hull; and
b. the starboard water inlet port and the starboard water intake scoop are located on the bottom wall of the hull near the stern of the hull.

7. A wave shaping device for a boat as in claim 2, wherein:
a. the port water inlet port and the port water intake scoop are located on the port side wall of the hull near the stern of the hull; and
the starboard water inlet port and the starboard water intake scoop are located on the starboard side wall of the hull near the stern of the hull.

8. A wave shaping device for a boat as claimed in claim 2, wherein, when in the active position the port intake scoop and the starboard intake scoop are position at an angle relative the side wall of the hull in a range of from about 20° to about 70°.

9. A wave shaping device for a boat as in claim 1, wherein:
a. the port water intake scoop is slidably mounted to the hull adjacent a rearward side of the port water inlet port, and the port actuator selectively translates the port water intake scoop between the inactive position and the active position; and
b. the starboard water intake scoop is slidably mounted to the hull adjacent a rearward side of the starboard water inlet port, and the starboard selectively translates the starboard water intake scoop between the open and closed positions.

10. A wave shaping device for a boat as in claim 1, wherein:
a. the port water inlet port and the port water intake scoop are located on the bottom wall of the hull near the stern of the hull; and
b. the starboard water inlet port and the starboard water intake scoop are located on the bottom wall of the hull near the stern of the hull.

11. A wave shaping device for a boat as in claim 10, further comprising:
a. a second port water inlet port and a second port water intake scoop located on the port side wall of the hull, with the first end of the port water conduit in communication with the second port water inlet port; and
b. a second starboard water inlet port and a second starboard water intake scoop located on the starboard side wall of the hull, with the first end of the starboard water conduit in communication with the second starboard water inlet port.

12. A wave shaping device for a boat as in claim 1, wherein:
a. the port water inlet port and the port water intake scoop are located on the port side wall of the hull near the stern of the hull; and
b. the starboard water inlet port and the starboard water intake scoop are located on the starboard side wall of the hull near the stern of the hull.

13. A wave shaping device for a boat, the boat comprising a hull, the hull having a bow, a port sidewall, a starboard sidewall, a bottom wall and a stern wall, the bottom wall and the side walls converging from the rear wall to generally converge at the bow; a propulsion system for propelling the boat forward, the wave shaping device comprising:
a. a water inlet port in the hull toward the stern wall of the boat toward a first side of the boat relative to a center line of the boat and below the water line when the boat is floating;
b. a water outlet port in the hull located one of i) along the centerline of the boat and ii) toward a second side of the boat opposite the first side;
c. a water conduit inside the hull having a first end in communication with the water inlet port and a second end in communication with the water outlet port;
d. a water intake scoop that is selectively movable between i) an inactive position in which the water intake scoop does not extend beyond the outer surface of the hull and ii) an active position in which the water intake scoop extends beyond one of a side wall and bottom wall of the hull, whereby the water intake scoop directs ambient water into the water inlet port, through the water conduit and out the water outlet as the boat moves forward through the water; and
e. an actuator for moving the intake scoop between the inactive position and the active position.

14. A wave shaping device as in claim 13, wherein an outer surface of the water intake scoop when in the inactive position is flush with an outer surface of the hull.

15. A wave shaping device as in claim 13, wherein the water intake scoop covers the water inlet port when in the inactive position.

16. A wave shaping device as in claim 13, wherein a forward-facing surface of the water intake scoop when in the active position is a concave surface configured to smoothly redirect ambient water into the water inlet port.

17. A wave shaping device as in claim 13, wherein: a rearward edge of the water intake scoop is pivotally connected to the hull adjacent a rearward side of the water inlet port, and the actuator extends between the hull and a forward portion of the water intake scoop for pivoting the water intake scoop between the inactive position and the active position.

18. A wave shaping device as in claim 17, wherein the water intake scoop covers the water inlet port when in the inactive position.

19. A wave shaping device as in claim 18, wherein an outer surface of the water intake scoop when in the inactive position is flush with an outer surface of the hull.

20. A wave shaping device as in claim 17, wherein a forward-facing surface of the water intake scoop when in the active position is a concave surface configured to smoothly redirect ambient water into the water inlet port.

21. A wave shaping device as in claim 17, wherein the water inlet port and the water intake scoop are located on the bottom wall of the hull near the stern of the hull.

22. A wave shaping device as in claim 17, wherein the water inlet port and the water intake scoop are located on one of the side walls of the hull near the stern of the hull.

23. A wave shaping device as claimed in claim 17, wherein when in the active position the water intake scoops are position at an angle relative the side wall of the hull in a range of from about 20° to about 70°.

24. A wave shaping device as in claim 13, wherein
a. the propulsion system includes a propeller under the bottom wall of the hull near the stern of the hull; and
b. wherein the water inlet port and the water intake scoop are located on the bottom walls of the hull forward of the propellor.

25. A wave shaping device as in claim 13, wherein the water intake scoop is slidably mounted to the hull adjacent a rearward side of the port water inlet port, and the port actuator selectively translates the port water intake scoop between the inactive position and the active positions.

26. A wave shaping device as in claim 13, wherein:
a. the water inlet port is a port water inlet port located toward the port side of the boat;
b. the water intake scoop is a port water intake scoop located toward the port side of the boat near the stern of the hull;
c. the water outlet port is a port water outlet port located toward the starboard side of the boat near the stern of the hull;
d. the actuator is a port actuator located on the port side of the boat,
e. the water conduit is a port water conduit inside the hull having a first end in communication with the port water inlet port and a second end in communication with the port water outlet port; and
f. further comprising:
g. a starboard water inlet port in the hull located toward the starboard side of the boat near the stern of the hull;
h. a starboard water intake scoop on the hull located toward the starboard side of the boat near the stern of the hull;
i. a starboard actuator for moving the starboard intake scoop between an inactive position and an active position
j. a starboard water outlet port located toward the port side of the boat near the stern of the hull; and
k. a starboard water conduit inside the hull having a first end in communication with the starboard water inlet port and a second end in communication with the starboard water outlet port.

27. A wave shaping device for a boat as in claim 26, further comprising:
a. a second port water inlet port and a second port water intake scoop located on the port side wall of the hull, with the first end of the port water conduit in communication with the second port water inlet port; and
b. a second starboard water inlet port and a second starboard water intake scoop located on the starboard side wall of the hull, with the first end of the starboard water conduit in communication with the second starboard water inlet port.

28. A wave shaping device for a boat, the boat having a hull, the hull having a bow, a port sidewall, a starboard sidewall, a bottom wall and a stern wall, the bottom wall and the side walls extend forwardly from the rear wall, forward portions of the side walls generally converge at the bow; a propulsion system for propelling the boat forward, the wave shaping device comprising:
a. a water inlet port in the hull of the boat toward a first side of the boat located below the water line when the boat is floating;
b. a water outlet port in the hull of the boat located one of i) along the centerline of the boat and ii) toward a second side of the boat;
c. a water conduit inside the hull, a first end of the water conduit in communication with the water inlet port and a second end of the port water conduit in communication with the water outlet port for directing ambient water from the port water inlet port to the water outlet port;
d. an intake scoop that is selectively movable between a) an inactive position in which the water intake scoop does not extend beyond an outer surface of the hull and b) an active position in which the water intake scoop extends beyond the outer surface of the hull, whereby the water intake scoop directs ambient water into the water inlet port as the boat moves forward through the water; and
e. an actuator for selectively moving the intake scoop between the inactive position and the active position.

29. A method of shaping a wake produced by a boat, the boat having a hull, the hull having a bow, a port sidewall, a starboard sidewall, a bottom wall and a stern wall, the bottom wall and the side walls extend forwardly from the rear wall, forward portions of the side walls generally converge at the bow; a jet propulsion system having a forward facing water intake opening in the bottom wall of the hull for receiving ambient water when the boat is floating, a jet propulsion unit for receiving water from the intake opening and accelerating the water, and a jet nozzle for receiving the accelerated water from the jet propulsion unit and emitting a water jet in a rearward direction relative to the boat for propelling the boat forward, the wave shaping method comprising:
a. selectively directing ambient water one of 1) from the port side of the boat to the water intake of the jet propulsion system and 2) from the starboard side of the boat to the water intake of the jet propulsion system.

30. A method of shaping a wake produced by a boat, the boat having a hull, the hull having a bow, a port sidewall, a starboard sidewall, a bottom wall and a stern wall, the bottom wall and the side walls extend forwardly from the rear wall, forward portions of the side walls generally converge at the bow; a propulsion system for propelling the boat forward, the wave shaping method comprising:
a. redirecting ambient water from a first side of the boat to one of 1) a center of the boat and 2) an opposite second side of the boat.

31. The method according to claim 30, wherein the step of redirecting water comprises selectively directing ambient water one of 1) from the port side of the boat to the starboard side of the boat and 2) from the starboard side of the boat to the port side of the boat.

32. The method according to claim 31, further comprising;
a. providing a port water inlet port in the hull of the boat on the port side portion of the boat located below the water line when the boat is floating;
b. providing a port water conduit inside the hull, a first end of the port water conduit in communication with the port water inlet port and a second end of the port water conduit in communication with the water intake opening of the jet propulsion system for directing ambient water from the port water inlet port to the water intake opening;
c. providing a port intake scoop that is selectively movable between a) an inactive position in which the port water intake scoop does not extend beyond the side walls or bottom wall of the hull and b) an active position in which the port water intake scoop extends beyond one of a side wall and bottom wall of the hull, whereby the port intake scoop directs ambient water into the port water inlet port as the boat moves forward through the water;
d. providing a port actuator for selectively moving the port intake scoop between the inactive position and the active position;
e. providing a starboard water inlet port in the hull of the boat on the starboard side portion of the boat located below the water line when the boat is floating;
f. providing a starboard water conduit inside the hull, a first end of the starboard water conduit in communication with the starboard water inlet port and a second end of the starboard water conduit in communication with the water intake of the jet propulsion system for directing ambient water from the starboard water inlet port to the water intake opening;
g. providing a starboard intake scoop that is selectively movable between a) an inactive position in which the starboard water intake scoop does not extend beyond the side walls or bottom wall of the hull and b) an active position in which the starboard water intake scoop extends beyond one of a side wall and bottom wall of the hull, whereby the starboard intake scoop directs ambient water into the starboard water inlet port as the boat moves forward through the water; and
h. providing a starboard actuator for selectively moving the starboard intake scoop between the inactive position and the active position;
i. wherein the step of selectively redirecting water comprises, selectively one of:
1) moving the port intake scoop to the active position while retaining the starboard intake scoop in the inactive position, thereby redirecting water from the port side of the boat to the water intake of the jet propulsion system; and
2) moving the starboard intake scoop to the active position while retaining the port intake scoop in the inactive position, thereby redirecting water from the port side of the boat to the water intake of the jet propulsion system.

33. A method according to claim 32, further comprising the step of maintain the port side water intake scoop and the starboard side water intake scoop in the inactive position when traveling at speeds greater than about 15 mph.

34. A method according to claim 32, wherein:
a. the port water inlet port and the port water intake scoop are provided on the bottom wall of the hull near the stern of the hull; and
b. the starboard water inlet port and the starboard water intake scoop are provided on the bottom wall of the hull near the stern of the hull.

35. A method according to claim 34, further comprising the steps of:
a. providing a second port water inlet port and a second port water intake scoop located on the port side wall of the hull, with the first end of the port water conduit in communication with the second port water inlet port; and
b. a second starboard water inlet port and a second starboard water intake scoop located on the starboard side wall of the hull, with the first end of the starboard water conduit in communication with the second starboard water inlet port.

36. A method according to claim 32, wherein:
a. the port water inlet port and the port water intake scoop are provided on the port side wall of the hull near the stern of the hull; and
b. the starboard water inlet port and the starboard water intake scoop are provided on the starboard side wall of the hull near the stern of the hull.
